(19) United States
(12) Patent Application Publication
(10) Pub. No.: US 2016/0267542 A1
(43) Pub. Date: Sep. 15, 2016

(54) SYSTEM FOR CUSTOMIZING CONTENT

(71) Applicants: Adarsh JAIN, Greater Noida (IN); Vinish KATHURIA, Gurgaon (IN); Aakash Rao Nallabothula Surya, Visakhapatnam (IN)

(72) Inventors: Adarsh JAIN, Greater Noida (IN); Vinish KATHURIA, Gurgaon (IN); Aakash Rao Nallabothula Surya, Visakhapatnam (IN)

(73) Assignee: HT MOBILE SOLUTIONS LTD, New Delhi (IN)

(21) Appl. No.: 14/645,423

(22) Filed: Mar. 12, 2015

(51) Int. Cl. G06Q 30/02; G06Q 50/00

(52) U.S. Cl. CPC G06Q 30/0269; G06Q 30/0202; G06Q 50/01

(57) ABSTRACT

A system (100) for customizing content. The system (100) comprises a personality determination system (102) and a content customization system (108). The personality determination system (102) is configured to; access social networking data of the consumers, and thereafter, process the social networking data of the consumers to create a personality model of the consumers. The content customization system (108) is configured to, access the personality model of the consumers and thereafter, customize the content as per the personality model of the consumers. An algorithm to customize the content based on the personality model of the consumers is based on an OCEAN model of determining personality model of the consumers. The customized content is delivered to the consumers devices by a content delivery system (118).

### BACKGROUND

1. Field

In general, the subject matter relates to the field of electronically delivering content to consumers of content. More particularly, but not exclusively, the subject matter relates to customizing the content delivered to consumers, based on the personality of the consumer.

2. Discussion of related field

With the advent of internet and mobile phones, advertising has also moved from an outdoor environment to advertising on display devices such as mobile phones and CRT monitors, among others. The content such as advertisements are delivered to display devices of consumers to attract the consumer's attention.

There exist techniques, wherein advertisements relevant to the consumer are delivered to the display devices of the consumer. Such techniques involve delivering relevant advertisements to the consumer, based on the consumer's interests and preferences. By delivering advertisements relevant to the consumer, there would be a better chance of the advertisement grabbing the attention of the consumer. To deliver relevant advertisements to the consumers, techniques in the art employ methods to determine the consumer's interests and preferences by analyzing the search and internet browsing pattern of consumers. Upon analyzing such patterns, advertisements, which are related to these patterns are displayed on the consumer's display devices. Such techniques hope to evoke interest in the consumers regarding the product being advertized, and have a greater chance of a sale, as the advertisements being displayed are related to the consumer's interests.

Further, there exist techniques, wherein relevant advertisements are delivered to consumers based on a test taken by the consumer, to determine the user's personality.

With the advent of social media websites, and participation of a substantial section of the population in social media websites such as facebook and twitter, consumers of such sites are participating in various activities and generating data. This data can pertain to the likes and preferences of the consumers.

Techniques in the art try to deliver relevant content and advertisements to consumers on their display devices based on the search and browsing patters of the consumers. However, such techniques fail to customize the content such as advertisements themselves to suit the personality of the user.

In light of the foregoing discussion, there is a need for a technique wherein, the personality of the consumer is determined based on analysis of data obtained by social media websites, and thereafter delivering relevant and customized content such as advertisements to the display devices of the consumers.

### SUMMARY

In an embodiment, a system for customizing content is disclosed. The system comprises a personality determination system and a content customization system. The personality determination system is configured to, access social networking data of the consumers, and thereafter, process the social networking data of the consumers to create a personality model of the consumers. The content customization system is configured to, access the personality model of the consumers and thereafter, customize the content as per the personality model of the consumers. An algorithm to customize the content based on the personality model of the consumers is based on an OCEAN model of determining personality model of the consumers. The customized content is delivered to the consumers devices by a content delivery system.

Another embodiment provides a method for customizing content. The method comprises of determining a personality model of the consumer and thereafter customizing the content such as advertisements, based on the personality model of the consumer. The method further comprises of delivering the customized content to the consumers devices.

### BRIEF DESCRIPTION OF DRAWINGS

Embodiments are illustrated by way of example and not limitation in the Figures of the accompanying drawings, in which like references indicate similar elements and in which:

FIG. 1 is a block diagram of an exemplary content customization and delivery system 100, in accordance with an embodiment;

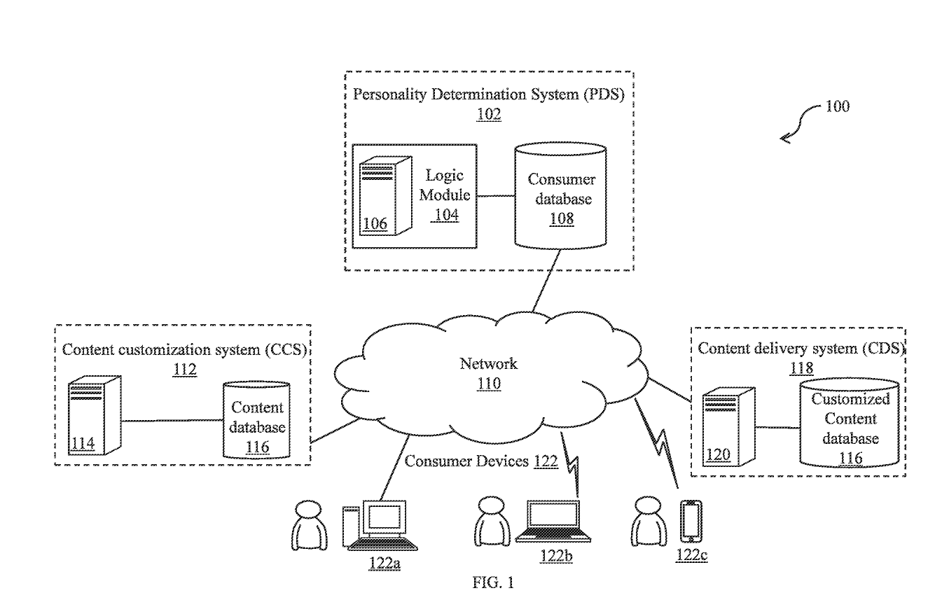

FIG. 2 is an example data flow diagram of an example data flow 200, in accordance with an embodiment;

FIG. 3 is a flowchart of an exemplary method for creating logic to determine personality type of consumers based on certain data, in accordance with an embodiment;

FIG. 4 is a flowchart of an exemplary method for creating a consumer personality model and thereafter, based on the personality model, customizing and delivering content to users, in accordance with an embodiment; and

FIG. 5 is a block diagram of a generic processing device, which may be used to execute methods and processes disclosed.

### DETAILED DESCRIPTION

I. CONTENT CUSTOMIZATION AND DELIVERY SYSTEM OVERVIEW
II. EXEMPLARY PERSONALITY DETERMINATION SYSTEM
III. EXEMPLARY CONTENT CUSTOMIZATION SYSTEM
IV. EXEMPLARY CONTENT DELIVERY SYSTEM
V. EXEMPLARY DATA FLOW
VI. EXEMPLARY METHOD TO DETERMINE LOGIC OF PERSONALITY DETERMINATION SYSTEM
VII. EXEMPLARY METHOD TO DETERMINE CONSUMER PERSONALITY, CUSTOMIZE AND DELIVER CONTENT TO CONSUMER'S DEVICE
VIII. EXEMPLARY GENERIC PROCESSING DEVICE
IX. EXAMPLE
X. CONCLUSION

### I. CONTENT CUSTOMIZATION AND DELIVERY SYSTEM OVERVIEW

Embodiments relate to technique for determining a consumer's personality type, and based on the personality, customizing and delivering content to the consumer's devices.

In an embodiment, a system 100 to enable determination of consumer personality type and thereafter, customizing and delivering content based on consumer personality is provided. The system 100 comprises a personality determination system 102, a content customization system 112 and a content delivery system 118. The personality determination system 102 may be configured to determine and create a personality model of the consumer by processing social networking data of the consumer. Upon determining and creating the personality model of the consumer, the content customization system 112 may be configured to customize the content based on the personality model of the consumer. The content may be customized such that, it appeals to the personality type of the consumer. Upon customizing the content, the content delivery system 118 may be configured to deliver the content to the consumer's devices.

In an embodiment, the content may include advertisements. The content may be a single advertisement or a group of advertisements. The group of advertisements may be related to a similar concept of advertisements, which are intended to target the consumer.

In an embodiment, the content such as advertisements, may be displayed to the consumer, along with other content. For example: The advertisement may be displayed on a web page to the consumer, along with other content, which may not be part of the advertisement. The advertisement may be rendered within the page such that, it seamlessly integrates within the webpage.

The advertisements may be displayed on the consumer's devices 122. The consumer devices may be a desktop 122a, laptop 122b and a mobile phone 122c, among other generic consumer display devices 122.

The content may be communicated to the consumer devices 122 through a network 110. The network 110 may include telecommunication networks, such as, internet, telephone networks and computer networks among other networks configured to facilitate communication.

The personality determination system 102, hereinafter referred to as PDS 102, may be configured to determine and create a personality model of consumers. The PDS 102 may have access to the consumer's data such as social networking data. The social networking data of the consumer may relate to various data such as, likes, interests and status messages shared by the consumer on the social networking sites. Such data may be obtained from social networking websites such as facebook, twitter and google plus, among other social networking sites. The PDS 102 may process the social networking data of the consumers, and thereafter determine the personality of the consumer. The PSD 102 may also create a personality model of a user. The PSD 102 may be configured to communicate with the consumer's devices 122 and the content customization system 112.

The content customization system 112, hereinafter referred to as CCS 112, may be configured to customize the content such as, advertisements. The CSS 112 may be configured to communicate with the PDS 102 and the content delivery system 118. The CCS 112 may customize the content based on the personality model of the consumer created by the PDS 102. Upon customizing the content, the CCS 112 may communicate the customized content to the content delivery system 118.

The content delivery system hereinafter referred to as CDS 118 may be configured to communicate the customized content to the consumer's devices 122. The CDS 118 may be configured to communicate with the CCS 112 and the consumer's devices 122.

The following detailed description includes references to the accompanying drawings, which form a part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiment can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### II. EXEMPLARY PERSONALITY DETERMINATION SYSTEM

The PDS 102 may include a logic module 104, at least one data processing system 106 and a consumer database 108. The logic module 104 may be embedded in the one or more data processing systems 106. The data processing systems 106 may be servers or embedded systems. The logic module 104 embedded in the data processing system 106 may relate to logic to determine the personality of the consumer. The logic module 104 may include logic to correlate for example: likes, preferences and expressed messages of the consumer to traits of personality. The logic module 104 may be configured to access the consumer database 108. The consumer database 108 may include data relating to but not limiting to, details of consumers, consumer's social networking activities such as, status messages, likes, interests and preferences, among others. The logic module 104 may processes the data included in the consumer database 108 and thereafter based on the logic relating to correlating of consumer social networking data to personality, create a personality model for each of the consumers. In an embodiment, the logic may incorporate concepts of determining personality such as determining five traits of personality, “openness, conscientiousness, extraversion, agreeableness, and neuroticism”, commonly acronymed as, OCEAN. The likes, preference, status messages and choices of the consumer for example: Color, products, automobiles, movies of certain genre, celebrities and food among others may be correlated to determine the personality type of the consumer. For example, the processing of twitter messages of the consumer may be used to determine the personality type of the consumer.

The data processing systems 106 may be further configured to access social networking data of consumers. The social networking data of the consumers may be publicly available. The social networking provider or the consumer may also provide access to their data to the data processing systems 106. The data processing systems 106 may be configured to crawl social networking sites to extract data relating to the consumer's social networking activity. The data extracted by the data processing systems 106 may be stored in the consumer database 108. Upon creating the personality model of the consumers, the personality model pertaining to each of the consumer can be stored in the consumer database 108. The personality model may be created for each and every consumer present in the consumer database 108. The PDS 102 may be configured such that, the personality model of the consumer is updated, as and when newer data is available. The creation of personality model of the consumer may be dynamic, and subject to change, as and when more and newer data is available. The PDS 102 may communicate with social networking sites through the network 110.

### III. EXEMPLARY CONTENT CUSTOMIZATION SYSTEM

The CCS 112 may include at least one data processing system 114 and a content database 116. The data processing systems 114 may be servers or embedded systems. The data processing systems 114 may be configured to access the content database 116. In an embodiment, the content database may be located on an external server. In another embodiment, the content database may be located within the data processing systems 114. For example: Content may be located on an external server maintained by an advertiser. Logic may be embedded in the data processing systems 114. The logic may pertain to customizing the content based on the personality model of the consumers created by the PDS 102. The logic embedded in the data processing systems 114 may further pertain to correlating the type of content which may appeal to the personality type of the consumer. For example: If the consumer, likes the color red or is fond of a certain footballer, the content can be customized to appeal to the consumer, which may result in the consumer noticing the advertisement and thereby resulting in better brand recollection or sale of a product. The CCS 112 may be configured to communicate with the PDS 102 and the CDS 118. The personality model of a consumer created by the PDS 102 may be accessed by the CCS 112. Thereafter, the CCS 112 may customize the content included in the content database 116, as per the personality of the type of the consumer. The CCS 112 may be configured such that, content may be customized for each of the consumer personality model created by the PDS 102. The customized content may be communicated to the CDS 118.

### IV. EXEMPLARY CONTENT DELIVERY SYSTEM

The CDS 118 may include at least one data processing system 120 and a customized content database 116. The data processing systems 120 may be servers or embedded systems. The data processing systems 120 may be configured to access the customized content database 116. The customized content may be communicated from the CCS 112 to the customized content database 116. The CDS 118 may have access to a list of target consumers, whose personality model has been created by the PDS 102. The CDS 118 may be configured to be accessed by advertisers who wish to deliver customized advertisements to the target consumer list. The CDS 118 may be further configured to enable advertisers to set custom fields for targeting consumers of certain personality models. The CDS 118 may be configured to communicate customized content to the consumer's devices 122. In another embodiment, the CDS 118 may be configured to deliver the customized content along with the list of target consumer list to an external server, which may thereafter deliver the customized content to the consumer's devices 122. The customized content may be delivered to the consumer devices, embedded with other content.

### V. EXEMPLARY DATA FLOW

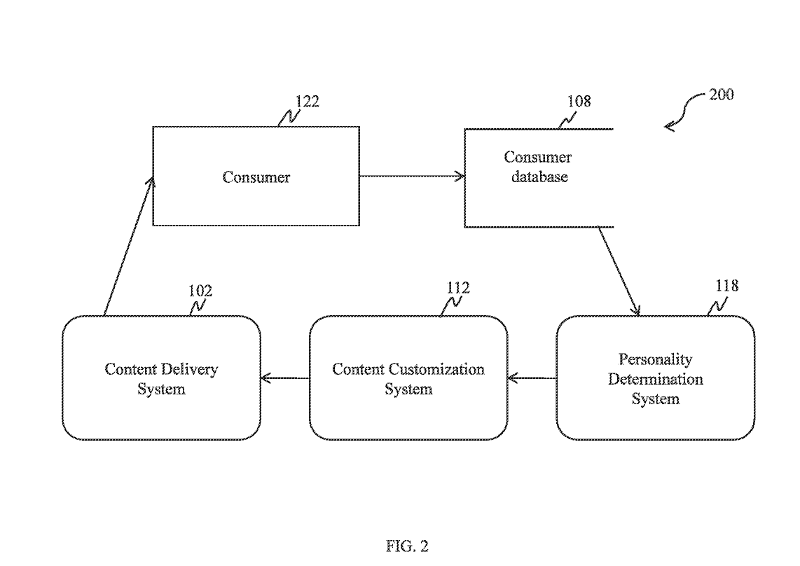

FIG. 2 is an example data flow diagram of an example data flow 200, in accordance with an embodiment. Other data flows may be possible, and the illustrated events and their order may vary.

As illustrated in FIG. 2, when a consumer 122 indulges in social networking activity on social networking sites, the social networking data may be accessed and stored in a consumer database 108. The PDS 118 may access the consumer database 108 and thereafter determine and create a personality model of the consumers. The CCS 112 may access the personality model of the consumers, and thereafter customize the content according to the personality model of the consumers. The CDS 102 may access the customized content, and deliver the customized content to the relevant consumer 122.

### VI. EXEMPLARY METHOD TO DETERMINE ALGORITHM OF PERSONALITY DETERMINATION SYSTEM

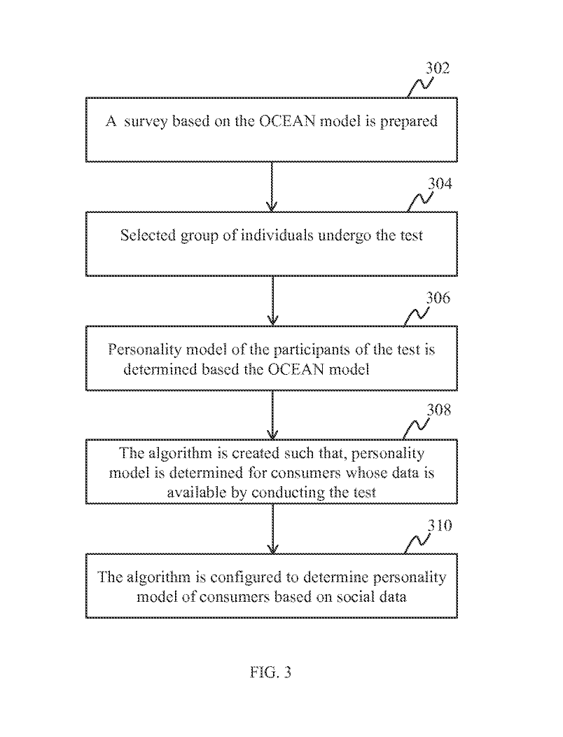

FIG. 3 is a flowchart of an exemplary method for creating logic or algorithm to determine personality model of consumers based on certain data, in accordance with an embodiment. At step 302, a survey may be devised in the form of a questionnaire based for example, on the concepts of OCEAN model to determine a personality model of consumers. In other embodiments, other models to determine personality model may also be used. The questionnaire may be such that, upon answering and processing, the personality traits of the participant may be determined. At step 304, the survey may be conducted on volunteers, who may also have social networking profiles on social networking sites. The number of participants of the survey may be based on the number of participants required to accurately determine personality traits of the participants, based on the answers. The larger the number participants, the more accurate the results may be. At step 306, the personality model of the participants may be determined based on the chosen concepts of personality determination such as the OCEAN model. At step 308, an algorithm may be created to determine the personality model of the participants of the survey such that, the personality model determined by the algorithm matches with the personality model determined by conducting the survey on participants. At step 310, the algorithm may be configured to determine personality model of consumers by processing the social data of consumers such as social posts, likes and choices. The algorithm upon creation may automatically determine personality model of consumers by processing the social data of consumers. In an embodiment, the algorithm may be configured such that, the algorithm is updated to determine personality model of accurately.

the personality type of the volunteers determined based on the survey can be utilized to determine a logic to further determine personality attributes of new consumers. At step 310, logic may be devised to automatically correlate activities of consumers of social networking sites, such as choices and likes to certain personality attributes of the consumers.

### VII. EXEMPLARY METHOD TO DETERMINE CONSUMER PERSONALITY, CUSTOMIZE AND DELIVER CONTENT TO CONSUMER'S DEVICE

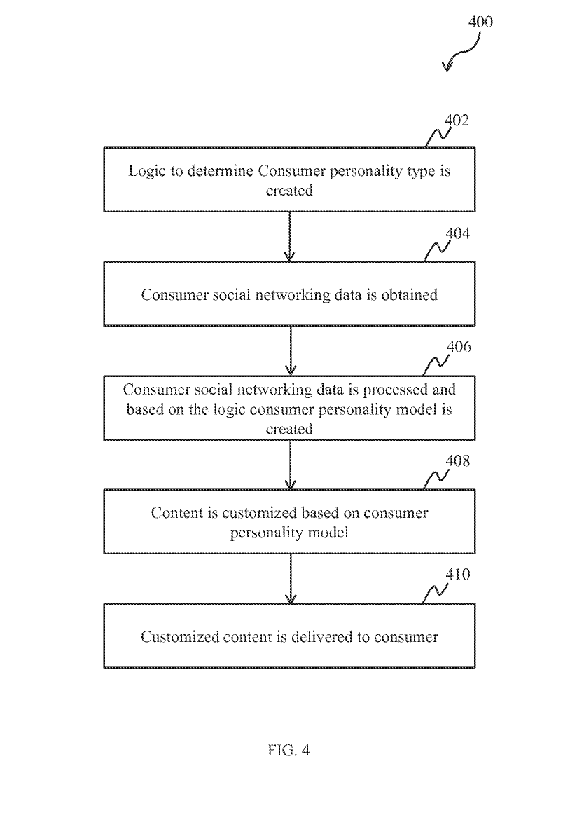

FIG. 4 is a flowchart of an exemplary method 400 for creating a consumer personality model and thereafter, based on the personality model, customizing and delivering content to users, in accordance with an embodiment. At step 402, the logic to determine consumer personality type is created and embedded in the data processing system. At step 404, the data relating to activities of consumers on social networking sites may be obtained. The activities may pertain to status messages, likes, preferences and choices of the consumer on the social networking sites. The obtained data may be stored on a database. At step 406, the data is processed by the PDS 102 and a personality mode of the consumer may be created. At 408, the CCS 112 may customize content such as advertisements, based on the personality model of the consumer. At step 410, the CDS 118 may deliver the customized content to the consumer's devices 122.

### VIII. EXEMPLARY GENERIC PROCESSING DEVICE

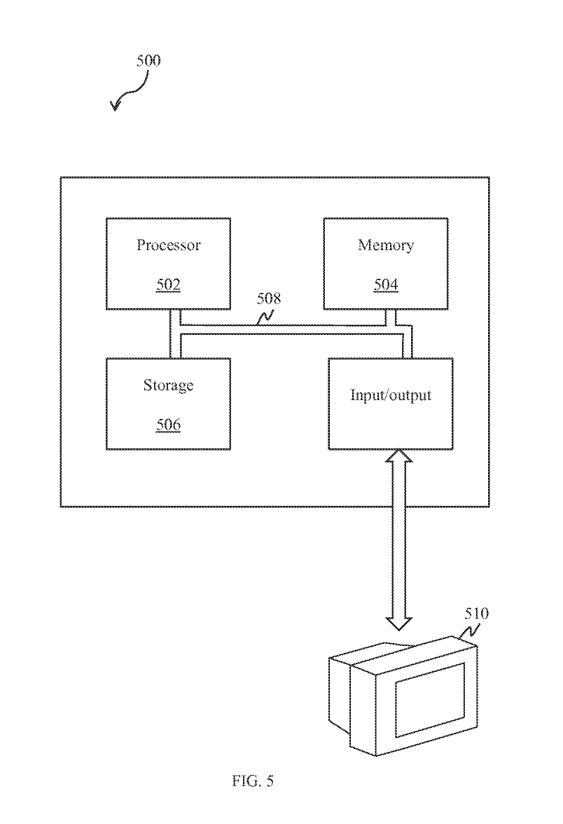

FIG. 5 is a block diagram of a generic processing device, which may be used to execute methods and processes disclosed. System 500 may be used for the operations described in association with the method 400, in accordance with an embodiment. The system 500 may also be used for the operations described in association with the method 400 according to other embodiments. For example, the system 500 may be included in either or all of the PDS 102, CCS 112 and CDS 118. The system 500 may includes a processor 502, a memory 504, a storage device 506 and an input/output device. The components 502, 504, 506 may be connected using a system bus 508.

The processor 502 may be capable of processing instructions within the system 500. The processor 502 may be capable of processing instructions stored in the memory 504 or on the storage device 506 to display information for a user interface on the input/output device 510.

The memory 504 may store information within the system 500. In an embodiment, the memory 504 may be a computer-readable medium.

The storage device 506 may be capable of providing mass storage for the system 500. In an embodiment, the storage device 506 may be a computer-readable medium. In another embodiments, the storage device 506 may be a floppy disk device, a hard disk device, an optical disk device, or a tape device.

The input/output device 510 provides input/output operations for the system 500.

The features described may be implemented in digital electronic circuitry, or in computer hardware, firmware, software, or in combinations of them. The apparatus may be implemented in a computer program product tangibly embodied in an information carrier, e.g., in a machine-readable storage device or in a propagated signal, for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

### IX. EXAMPLE

A consumer may have a social networking profile on example social networking sites such as, facebook and twitter. The consumer may indulge in various activities on the social networking sites such as, liking certain posts, sharing certain messages among other activities. Such activities are accessed and processed by the content customization and delivery system 100. Upon obtaining such data, based on preconceived logic, the personality model of the consumers are created. The advertisement content which is to be communicated to the consumer's devices, is customized based on the personality type of the consumer. The customized content is then delivered to the consumer's devices such as desktops 122a, laptops 122b and mobile phones 122c among others.

### X. CONCLUSION

In light of the above disclosure, it is evident that, the present invention has many advantages over existing technologies. Some of those advantages are mentioned below:
The instant technique focuses on customizing the content of the advertisements, rather than focusing only on targeting the right content for the consumer.
By customizing the content of the advertisements, there may be a greater chance of appealing to the consumer, as the content is as per the consumer's personality.
The instant technique by creating a personality model for each consumer, delivers customized content to each consumer. The content delivered to each of the consumer may be different.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications; these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A system for customizing content, the system comprising:
a personality determination system configured to:
access social networking data of the consumers; and
process the social networking data of the consumers to create a personality model of the consumers; and
a content customization system configured to:
access the personality model of the consumers; and
customize content as per the personality model of the consumers.

2. The system according to claim 1, wherein an algorithm to derive the personality model is obtained at least from a survey conducted on a group of participants.

3. The algorithm according to claim 1, wherein an algorithm to derive the personality model is obtained at least from a survey conducted on a group of participants, wherein the survey is based on an OCEAN model of deriving the personality model of the consumers.

4. The system according to claim 1, wherein, the personality model of the consumer dynamically changes in accordance with changes in the consumers social networking data.

5. The system according to claim 1, wherein the content is customized to appeal to the personality model of the consumer.

6. The system according to claim 1, wherein, the customized content is delivered to a consumer device.

7. The system according to claim 5, wherein the customized content is delivered to an external server.

8. A method for customizing content, the method comprising:
creating a personality model of the consumer; and
customizing the content based on the personality model of the consumer.

9. The method according to claim 8, the method further comprising, obtaining an algorithm to derive the personality model of the consumers by conducting a survey on a group of participants.

10. The method according to claim 8, the method further comprising, obtaining an algorithm to derive the personality model of the consumers by conducting a survey on a group of participants, the survey based on an OCEAN model of determining personality model of the consumers.

11. The method according to claim 8, the method further comprising, dynamically updating the personality model of the consumer in accordance with the changes in the consumers social networking data.

12. The method according to claim 8, the method further comprising, customizing the content to appeal to the personality type of the consumer.

13. The method according to claim 8, the method further comprising, delivering the customized content to a consumer device.

14. The method according to claim 13, the method further comprising delivering the customized content to an external server.

15. A system comprising:
a processor; and
a computer-readable medium operatively coupled to the processor and including instructions, which, when executed by the processor, causes the processor to perform operations comprising:
identifying and collecting social networking data of consumers;
creating a personality model of the consumers;
customizing advertisements to suit the personality model of the consumers; and
delivering the customized advertisements to the consumers devices.

16. The system according to claim 15, wherein the customized advertisements are delivered to an advertiser.

17. The system according to claim 15, wherein the personality model of the consumer is dynamically updated upon change in social networking data of the consumer.
